(19) United States
(12) Patent Application Publication
(10) Pub. No.: US 2008/0143641 A1
(43) Pub. Date: Jun. 19, 2008

(54) Plasma display and driving method thereof

(76) Inventors: Byung-Gwon Cho, Suwon-si (KR); Sang-Min Nam, Suwon-si (KR)

Correspondence Address: ROBERT E. BUSHNELL, 1522 K STREET NW, SUITE 300, WASHINGTON, DC, 20005-1202, US

(21) Appl. No.: 11/826,747

(22) Filed: Jul. 18, 2007

(30) Foreign Application Priority Data
Dec. 18, 2006 (KR) 10-2006-0129405

(51) Int. Cl. G09G 3/28

(52) U.S. Cl. 345/60

(57) ABSTRACT

A plasma display device and a driving method thereof. During a sustain period of a first subfield, a sustain discharge alternating waveform alternating between a Vs voltage and a −Vs voltage is applied to a sustain electrode while a scan electrode is supplied with a constant reference voltage. During an initialization period of a second subfield consecutive to the first subfield, a voltage of the sustain electrode is gradually decreased from a ground voltage to a negative voltage while a scan electrode is applied with the ground voltage, causing a weak discharge to be generated between the scan electrode and the sustain electrode and between the sustain electrode and an address electrode so that wall charges formed on each electrode are partially erased. Accordingly, a scan electrode driver does not need a power recovery circuit by applying the sustain discharge pulse only to the sustain electrode. In addition, an appropriate wall charge distribution can be achieved thus eliminating misfiring.

### CLAIMS OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on 18 Dec. 2006 and there duly assigned Ser. No. 10-2006-0129405.

### BACKGROUND OF THE INVENTION

1. Field of the Invention

A plasma display device and a driving method thereof.

2. Description of the Related Art

A plasma display device is a flat panel display that uses plasma generated by a gas discharge to display characters or images. It includes, depending on its size, a plasma display panel (PDP) wherein tens of millions of pixels are provided in a matrix format.

On a panel of the plasma display device, a field (e.g., 1 TV field) is divided into a plurality of subfields respectively having a weight, and each subfield includes a reset period, an address period, and a sustain period in a temporal manner. The reset period is for initializing the status of each discharge cell so as to facilitate an addressing operation on the discharge cell, and the address period is for selecting turn-on/turn-off cells (i.e. cells to be turned on or off) and accumulating wall charges to the turn-on cells (i.e. selected cells) by applying an address voltage thereto. The sustain period is for producing a discharge that displays an image in the addressed cells.

In a display panel of the plasma display device, a scan electrode and a sustain electrode operate as a capacitive load, and therefore a capacitive component formed by the scan electrode and the sustain electrode exists. Accordingly, a reactive power is required for applying a sustain discharge pulse during the sustain period. A circuit that recovers and reuses reactive power is called a power recovery circuit.

The scan electrode and the sustain electrode are respectively connected with a scan electrode driver and a sustain electrode driver for applying a driving voltage to the scan and sustain electrodes. In a plasma display device, a sustain discharge pulse is alternately applied to both of the scan electrode and the sustain electrode during the sustain period so as to generate a sustain discharge, and therefore the scan electrode driver and the sustain electrode driver each need an additional power recovery circuit. This adds to the complexity and expense of the plasma display device. What is needed is a less complex and less expensive plasma display device.

### SUMMARY OF THE INVENTION

It is therefore an object of the present invention to provide a simpler and less expensive plasma display device.

It is also an object of the present invention to provide a method of driving a plasma display device that results in a less complex design and a less expensive plasma display device.

According to one aspect of the present invention, there is provided a method of driving a plasma display device includes providing a plasma display device having a first electrode, a second electrode, and a third electrode arranged to cross the first and second electrodes, applying a sustain discharge pulse alternating between a second voltage that is less than a first voltage and a third voltage that is greater than the first voltage to the second electrode while the first electrode is biased with the constant first voltage during a sustain period of a first subfield among a plurality of subfields and gradually decreasing a voltage applied to the second electrode from a fourth voltage to a fifth voltage while the first electrode is biased with the first voltage during a first period of a second subfield that is consecutive to the first subfield, wherein the fourth voltage is less than the third voltage and greater than the second voltage and the fifth voltage is less than the first voltage. The method of driving can also include gradually decreasing a voltage applied to first electrode from the first voltage to a seventh voltage that is greater than the second voltage while the second electrode is biased with a sixth voltage that is greater than the first voltage and less than the third voltage during a reset period consecutive to the first period of the second subfield.

The third electrode can be biased with the first voltage during the sustain period of the first subfield and the first period of the second subfield. The third electrode can be biased with an eighth voltage that is greater than the first voltage and less than the third voltage during the first period of the second subfield. The second voltage can be of an equal magnitude and of opposite polarity to that of the third voltage. The fourth voltage can be of an equal electric potential to that of the first voltage. The fifth voltage can be of an equal electric potential to that of the second voltage. The first voltage has an electric potential that is an average of the second voltage and the third voltage.

According to another aspect of the present invention, there is provided a plasma display device that includes a plasma display panel (PDP) having a first electrode, a second electrode, and a third electrode arranged to cross the first and the second electrodes and a driver adapted to apply driving waveforms to each of the first electrode, the second electrode and the third electrode to produce an image, wherein the driver is further adapted to apply a sustain discharge pulse alternating between a second voltage that is less than a first voltage and a third voltage that is greater than the first voltage to the second electrode while applying a first voltage to the first electrode during a sustain period, the driver being further adapted to gradually decrease a voltage applied to the second electrode from a fourth voltage that is less than the third voltage to a fifth voltage that is less than the first voltage while a first voltage is applied to the first electrode during a first period consecutive to the sustain period.

The driver can be further adapted to gradually decrease a voltage applied to the first electrode from the first voltage to a seventh voltage that is greater than the second voltage while the second electrode is applied with a sixth voltage that is greater than the first voltage and less than the third voltage during a reset period consecutive to the first period. The driver can be further adapted to apply an eighth voltage to the third electrode during the first period, wherein the eighth voltage is greater than the first voltage and less than the third voltage. The second voltage can be of equal magnitude and opposite polarity to that of the third voltage. The fifth voltage can be of an equal electric potential to that of the second voltage. The first voltage can be of an electric potential that is an average of the second voltage and the third voltage.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic top plan view of a plasma display device of the present invention;

FIG. 2 is a driving waveform diagram of a plasma display device according to a first exemplary embodiment of the present invention;

FIG. 3 shows a wall charge distribution after a reset falling period of the second subfield when the display of FIG. 1 is driven by the waveforms of FIG. 2;

FIG. 4 shows a driving waveform diagram of the plasma display device according to a second exemplary embodiment of the present invention; and

FIG. 5 shows a driving waveform diagram of the plasma display device according to the third exemplary embodiment of the present invention.

### DETAILED DESCRIPTION OF THE INVENTION

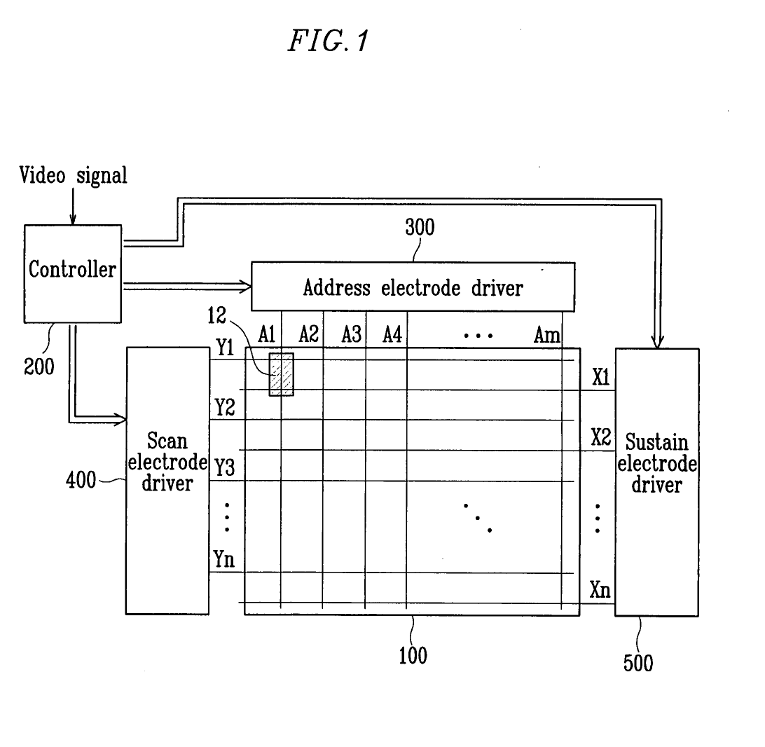

Turning now to the figures, FIG. 1 is a schematic top plan view of a plasma display device according to an exemplary embodiment of the present invention. As shown in FIG. 1, the plasma display device includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and a plurality of scan electrodes Y1 to Yn extending in a row direction as pairs. The sustain electrodes X1 to Xn respectively correspond to the scan electrodes Y1 to Yn, and the scan electrodes Y1 to Yn and the sustain electrodes X1 to Xn are arranged to cross the address electrodes A1 to Am and perform a display operation so as to display an image during a sustain period. A discharge space at a crossing region of one of the address electrodes A1 to Am and one each of the scan and sustain electrodes Y1 to Yn and X1 to Xn forms a discharge cell 12. The structure of the PDP 100 is merely exemplary, and panels of other structures can be used in the present invention.

The controller 200 receives an external video signal, outputs an address electrode driving control signal, a sustain electrode driving control signal, and a scan electrode driving control signal. In addition, the controller 200 divides the plasma display device by dividing a frame into a plurality of subfields. Each subfield includes a reset period, an address period, and a sustain period in a temporal manner. The address driver 300 receives address electrode driving control signals from the controller 200 and applies a display data signal to the respective address electrodes so as to select discharge cells to be displayed. The scan electrode driver 400 receives scan electrode driving control signals from the controller 200 and applies a driving voltage to the scan electrodes. The sustain electrode driver 500 receives sustain electrode driving control signals from the controller 200 and applies a driving voltage to the sustain electrodes.

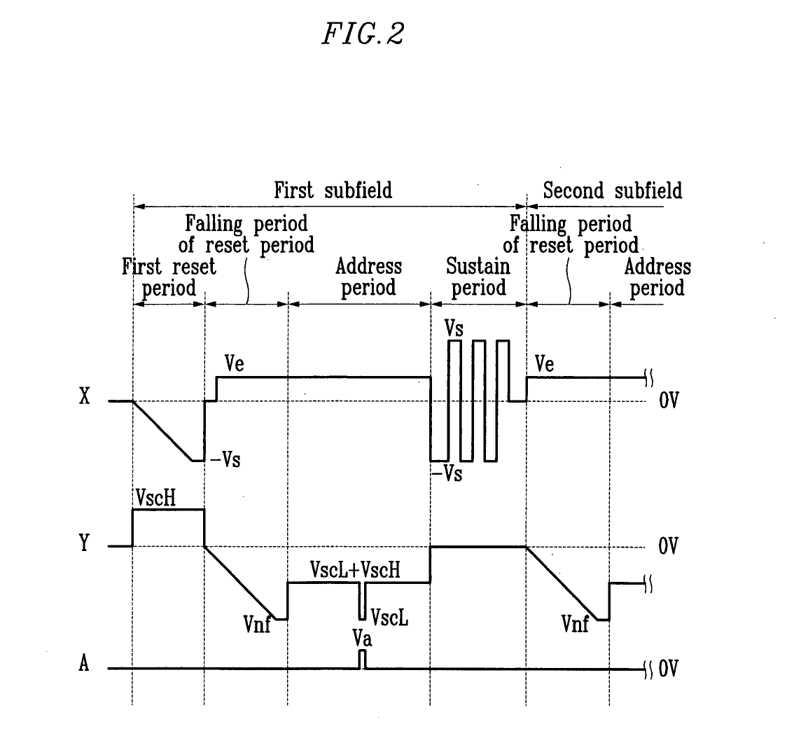

From now on, driving waveforms applied to the address electrodes A1 to Am, the sustain electrodes X1 to Xn, and the scan electrodes Y1 to Yn will be described in conjunction with FIGS. 2 through 5. Each of FIGS. 2, 4 and 5 are views of the driving waveform applied to an address electrode, a sustain electrode, and a scan electrode that form one cell 12. In FIGS. 2 through 5, the address, sustain, scan electrodes will be respectively referred to A, X, and Y electrodes.

According to the embodiments of the present invention, each time frame in the driving of the plasma display device is made up of a plurality of subfields, and each subfield is made up of a reset period, an address period and a sustain period. In order to prevent an occurrence of misfiring in a subsequent subfield, initialization of a wall charge state is required after the sustain period has terminated. Each of the subfields contain a reset falling period that initializes the wall charge state. In addition, at least one subfield may further include a first reset period to form a wall voltage between electrodes so as to initialize a wall charge state of all cells during the reset falling period. A subfield that does not include the first reset period includes an initialization period before the reset falling period to form a wall voltage to produce a stable weak discharge in the reset falling period.

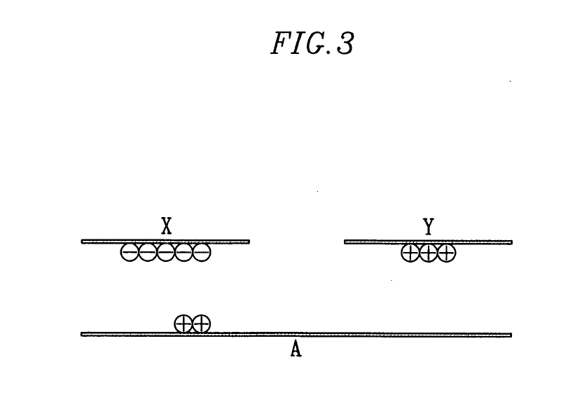

Turning now to FIGS. 2 and 3, FIG. 2 shows a driving waveform diagram of the plasma display device according to a first exemplary embodiment of the present invention, and FIG. 3 shows a wall charge distribution after the reset falling period of the second subfield when the waveforms of FIG. 2 are applied. FIG. 2 shows two consecutive subfields among a plurality of subfields of a frame, and for convenience of description, the two subfields are respectively referred to as a first subfield and a second subfield. In addition, FIG. 2 shows from the beginning of the first subfield to an address period of the second subfield. The first subfield performs initialization of a wall charge state by a first reset period and a reset falling period and the second subfield performs initialization of a wall charge state by only including a reset falling period.

As shown in FIG. 2, in the first reset period of the first subfield, a voltage applied to an X electrode is gradually reduced to a −Vs voltage while a voltage applied to a Y electrode and a voltage applied to an A electrode are biased with a VscH voltage and a reference voltage (i.e., 0V in FIG. 2), respectively. Subsequently, during the reset falling period of the first subfield, the voltage applied to the Y electrode is gradually reduced to Vnf where Vnf is equal to or less than −Vs, and a voltage applied to the X and A electrodes are Ve and reference zero respectively, causing a voltage difference between the Y and X electrodes and a voltage difference between the Y and A electrodes to gradually increase and produce a weak discharge between the X and Y electrodes and between the X and A electrodes. Due to the weak discharges, the positive (+) wall charges formed on the X electrode and the negative (−) wall charges formed on the A electrode are erased. In general, a (Ve−Vnf) voltage is set close to a discharge firing voltage Vfxy between the Y and X electrodes. As a result, a wall voltage between Y and X electrodes almost reaches 0V, and accordingly, the occurrence of misfiring of cells during a subsequent sustain period that have not experienced an address discharge during the address period can be prevented.

During the address period of the first subfield, a VscL voltage pulse, which may be equal to or less than Vnf, is sequentially applied to the plurality of Y electrodes while a Ve voltage is applied to the X electrode so as to generate an address discharge in selected discharge cells. At the same time, an address pulse having a Va voltage is applied to an A electrode that passes through selected discharge cells. As described, discharge cells formed by the A electrode applied with the address pulse and the Y electrode applied with the scan pulse experience an address discharge so that positive (+) wall charges are formed near the Y electrode and negative (−) wall charges are formed near the A electrode. As a result, the Y electrode of non-selected discharge cells is applied with a VscH voltage that is greater than the VscL voltage and an A electrode of the non-selected discharge cells is applied with the reference voltage.

After the address period is finished, a sustain period occurs where a sustain pulse alternately having the −Vs voltage and the Vs voltage is applied to the X electrode while the Y and A electrodes are each applied with a constant reference voltage. In general, the sustain pulse is a square wave having a −Vs sustain interval and a Vs sustain interval. As shown in FIG. 2, a first sustain pulse having the −Vs voltage is applied to the X electrode. Then, a sustain discharge is generated between the X and Y electrodes so that negative (−) wall charges are formed on the Y electrode and positive (+) wall charges are formed on the X electrode. Subsequently, a second sustain pulse having the Vs voltage is applied to the X electrode. Then, the sustain discharge is generated between the X and Y electrodes so that the positive wall charges are formed on the Y electrode and the negative wall charges are formed on the X electrode. During the sustain period of each subfield, the sustain pulse alternately having the −Vs voltage and the Vs voltage is applied to the X electrode a number of times corresponding to a weight value of the corresponding subfield.

During the reset falling period of the second subfield, the voltage of the Y electrode is gradually reduced to Vnf while the X and A electrodes are applied with the reference voltage. Then, as in the reset falling period of the first subfield, a weak discharge is generated between the Y and X electrodes and between the Y and A electrodes in the reset falling period of the second subfield, and thus the wall charges formed on the X and A electrodes are erased. An address period of the second subfield is the same as that of the first subfield, and therefore, a detailed description will not be further provided.

As described above, according to the first exemplary embodiment of the present invention, the sustain discharge pulse alternately having the −Vs voltage and the Vs voltage is applied to the X electrode while the Y and A electrodes are applied with the constant reference voltage during the sustain period, thereby generating a sustain discharge. Accordingly, a power recovery circuit for reuse of reactive power in the sustain period can be omitted from the scan electrode driver that applies the constant reference voltage to the scan electrode during the sustain period.

According to the first exemplary embodiment, while the X and A electrodes are respectively applied with the Ve voltage and the reference voltage respectively during the reset falling period of the second subfield, only the voltage of the Y electrode changes and is reduced to the Vnf voltage. As a result, the wall charges formed on the Y electrode and the X electrode are erased due to a weak discharge generated therebetween, and the wall charges formed on the Y electrode and the A electrode are erased due to a weak discharge generated therebetween.

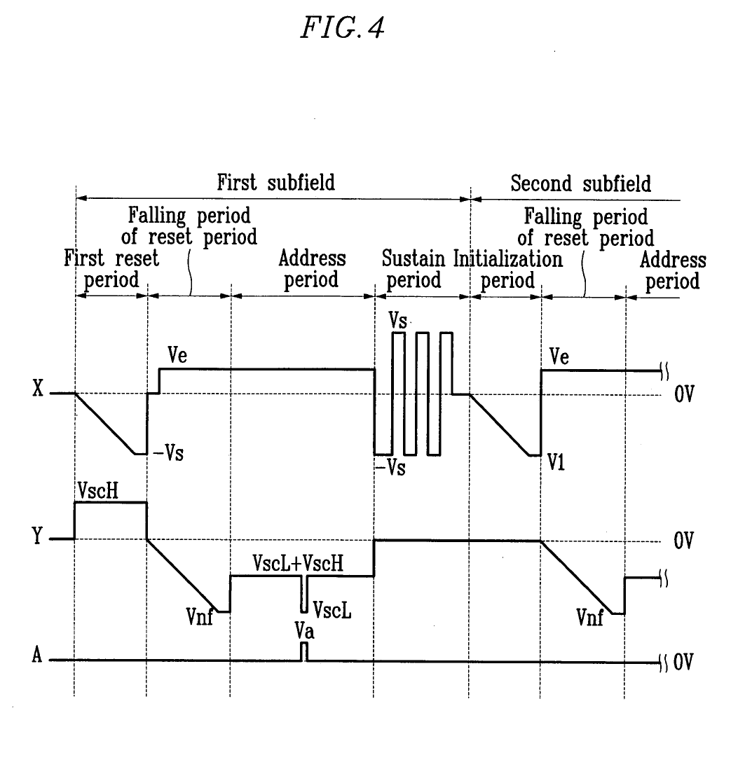

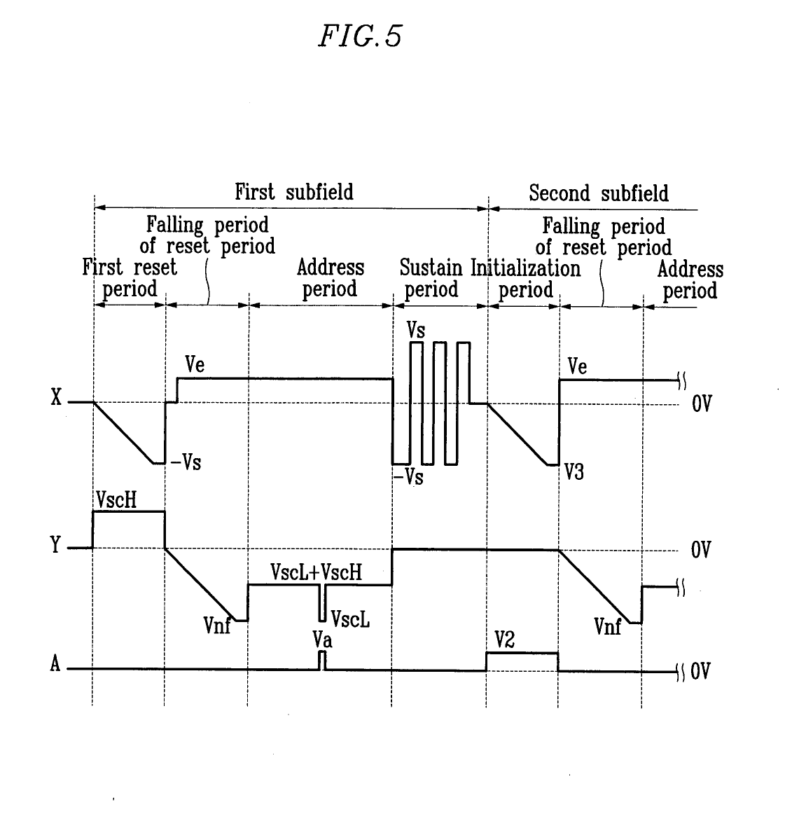

However, as shown in FIG. 3, the wall charges formed between the X electrode and the A electrodes may not erased during the reset period of the second subfield of FIG. 2 since a weak discharge may not generated between the X electrode and the A electrode. When the wall charges are not appropriately erased during the reset falling period, a misfiring can occur in a subsequent sustain period. According to second and third exemplary embodiments of the present invention, an initialization period is inserted between a first subfield and a second subfield for erasure of wall charges formed between an X electrode and an A electrode. This will now be described in more detail with reference to FIGS. 4 and 5.

Turning now to FIG. 4, FIG. 4 is a driving waveform diagram of the plasma display according to the second exemplary embodiment of the present invention. As shown in FIG. 4, the driving waveform of the second exemplary embodiment is the same as that of the first exemplary embodiment, except that an initialization period is provided between a first subfield and a second subfield.

During the initialization period of the second exemplary embodiment of the present invention, a voltage of the X electrode is gradually decreased to a V1 voltage from the reference voltage while the Y and A electrodes are applied with the reference voltage, the voltage V1 being equal to or greater than the −Vs voltage. Then, while the voltage of the X electrode is being decreased, a voltage difference between the X and Y electrodes and a voltage difference between the X and A electrodes are gradually increased, thereby causing a weak discharge to be generated between the X and Y electrodes and between the X and A electrodes. These weak discharges during this initialization period cause negative wall charges formed on the X electrode and a portion of the positive wall charges formed on the A and Y electrodes to be erased.

As the wall charges formed on the X and A electrodes are partially erased during the initialization period of the second subfield, a wall charge state of each electrode is initialized to an appropriate level for a subsequent sustain period even when a weak discharge is not generated between the X and A electrodes during a reset falling period of the second subfield. Therefore, unlike the first exemplary embodiment of FIG. 2, a misfiring in the sustain period can be prevented according to the second exemplary embodiment of the present invention.

Turning now to FIG. 5, FIG. 5 shows a driving waveform diagram according to a third exemplary embodiment of the present invention. As shown in FIG. 5, the driving waveform of the third exemplary embodiment of the present invention is the same as that of first exemplary embodiment of the present invention, except that an initialization period is further provided between a first subfield and a second subfield in the third exemplary embodiment of the present invention. In addition, similar to the second exemplary embodiment, the initialization period of the third exemplary embodiment is provided to erase wall charges formed between an X electrode and an A electrode during a reset falling period. However, unlike the second exemplary embodiment, the third embodiment of FIG. 5 applies a voltage V2, which is equal to or less than the Va voltage, to the A electrode during the initialization period.

In more detail, during the initialization period of the second subfield according to the third exemplary embodiment of the present invention, the voltage applied to the X electrode is gradually decreased to a V3 voltage from the reference voltage while the Y electrode and the A electrode are respectively applied with the reference voltage and the V2 voltage respectively, the voltage V3 being equal to or greater than the −Vs voltage. As a result, the voltage difference between the X and Y electrodes is V3 voltage and the voltage difference between the X and A electrodes is increased from V1 to V2-V3 while the voltage of the X electrode decreases. Accordingly, wall charges formed near X and A electrodes can be erased more efficiently than wall charges formed between the X and Y electrodes.

As described, since the wall charges formed between the X and A electrodes can be more efficiently erased than the wall charges formed between the X and Y electrodes during the initialization period of the second subfield, a wall charge state of each electrode can be initialized to be at an appropriate level for a subsequent sustain period even when a weak discharge is not generated between the X and A electrodes during a subsequent reset falling period of the second subfield. Therefore, differing from the first exemplary embodiment of the present invention, wall charges formed on each electrode can be appropriately initialized during the initialization period and the reset falling period such that a misfiring in a subsequent sustain period can be prevented by driving the electrodes according to FIG. 5.

According to the exemplary embodiments of the present invention, a sustain discharge pulse is applied only to the sustain electrode and thus the scan electrode driver does not need a power recovery circuit. In addition, a wall charge distribution state can be appropriately initialized by generating a weak discharge before a reset falling period, thereby stably initializing a wall charge state in a reset period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method, comprising:
providing a plasma display device comprising a first electrode, a second electrode, and a third electrode arranged to cross the first and second electrodes;
applying a sustain discharge pulse alternating between a second voltage that is less than a first voltage and a third voltage that is greater than the first voltage to the second electrode while the first electrode is biased with the constant first voltage during a sustain period of a first subfield among a plurality of subfields; and
gradually decreasing a voltage applied to the second electrode from a fourth voltage to a fifth voltage while the first electrode is biased with the first voltage during a first period of a second subfield that is consecutive to the first subfield, wherein the fourth voltage is less than the third voltage and greater than the second voltage and the fifth voltage is less than the first voltage.

2. The driving method of claim 1, further comprising gradually decreasing a voltage applied to first electrode from the first voltage to a seventh voltage that is greater than the second voltage while the second electrode is biased with a sixth voltage that is greater than the first voltage and less than the third voltage during a reset period consecutive to the first period of the second subfield.

3. The driving method of claim 1, wherein the third electrode is biased with the first voltage during the sustain period of the first subfield and the first period of the second subfield.

4. The driving method of claim 1, wherein the third electrode is biased with an eighth voltage that is greater than the first voltage and less than the third voltage during the first period of the second subfield.

5. The driving method of claim 1, wherein the second voltage is of an equal magnitude and of opposite polarity to that of the third voltage.

6. The driving method of claim 1, wherein the fourth voltage is of an equal electric potential to that of the first voltage.

7. The driving method of claim 1, wherein the fifth voltage is of an equal electric potential to that of the second voltage.

8. The driving method of claim 1, wherein the first voltage has an electric potential that is an average of the second voltage and the third voltage.

9. A plasma display device, comprising:
a plasma display panel (PDP) having a first electrode, a second electrode, and a third electrode arranged to cross the first and the second electrodes; and
a driver adapted to apply driving waveforms to each of the first electrode, the second electrode and the third electrode to produce an image, wherein the driver is further adapted to apply a sustain discharge pulse alternating between a second voltage that is less than a first voltage and a third voltage that is greater than the first voltage to the second electrode while applying a first voltage to the first electrode during a sustain period, and
the driver being further adapted to gradually decrease a voltage applied to the second electrode from a fourth voltage that is less than the third voltage to a fifth voltage that is less than the first voltage while a first voltage is applied to the first electrode during a first period consecutive to the sustain period.

10. The plasma display device of claim 9, wherein the driver is further adapted to gradually decrease a voltage applied to the first electrode from the first voltage to a seventh voltage that is greater than the second voltage while the second electrode is applied with a sixth voltage that is greater than the first voltage and less than the third voltage during a reset period consecutive to the first period.

11. The plasma display device of claim 9, wherein the driver is further adapted to apply an eighth voltage to the third electrode during the first period, wherein the eighth voltage is greater than the first voltage and less than the third voltage.

12. The plasma display device of claim 9, wherein the second voltage is of equal magnitude and opposite polarity to that of the third voltage.

13. The plasma display device of claim 9, wherein the fifth voltage is of an equal electric potential to that of the second voltage.

14. The plasma display device of claim 9, wherein the first voltage is of an electric potential that is an average of the second voltage and the third voltage.

15. The plasma display device of claim 10, wherein the first voltage is of an electric potential that is an average of the second voltage and the third voltage.

16. The plasma display device of claim 11, wherein the first voltage is of an electric potential that is an average of the second voltage and the third voltage.

17. The plasma display device of claim 12, wherein the first voltage is of an electric potential that is an average of the second voltage and the third voltage.

18. The plasma display device of claim 13, wherein the first voltage is of an electric potential that is an average of the second voltage and the third voltage.
